(19) United States
(12) Patent Application Publication
(10) Pub. No.: US 2014/0085542 A1
(43) Pub. Date: Mar. 27, 2014

(54) Method for embedding and displaying objects and information into selectable region of digital and electronic and broadcast media

(71) Applicants: Hicham Seifeddine, Montreal (CA); Bassel Tabbara, Laval (CA)

(72) Inventors: Hicham Seifeddine, Montreal (CA); Bassel Tabbara, Laval (CA)

(21) Appl. No.: 13/628,032

(22) Filed: Sep. 26, 2012

(51) Int. Cl. H04N 9/74

(52) U.S. Cl. 348/584; 348/E09.055

(57) ABSTRACT

The invention is a method of embedding objects and information in a transparent layer or medium situated seamlessly on the top of media like a movie or a still image. The media contains targeted visual element viewed or edited by users. The selectable region for embedding objects and information in the transparent layer or medium is defined by the location of the visual element in the movie or still image and by the movie elapsed time in case of playing a video media content. The embedded objects and information proper to the targeted visual element can be recalled and re-displayed on electronic and digital devices upon user actions such as but not limited to a click, tap or a mouse-over on the transparent layer in a specific area that is overlapping or surrounding the targeted visual element contained in the media content.

### SUMMARY OF THE INVENTION

A new seamless way to pull information, comments and objects related to a preferred visual element or any part of this visual element without the need of changing or adjusting the content of the original media work.

Placing a transparent layer which is a computer code on the top of a still image or a video content media is a medium that contains all information, comments and objects about specific visual elements or its ingredients. Users can embed comments, information and objects in the transparent layer in a location that overlap with the area covering this preferred visual elements. Same or other users can pull those specific comments, objects and information when seeing those specific visual elements and its ingredients after conducting an event such as but not limited to tap, mouse-over, mouse click in the area and its neighborhood where the visual elements and its ingredients are already targeted or marked.

### BACKGROUND OF THE INVENTION

At present many advertisers use product placement to promote their products and services. Those products and services are featured in different media contents such as: videos, still images, audio tracks, movies, TV shows, etc. In some cases, those featured products and services are not recognized or identified by the media viewers or those viewers require further information on those featured product and services where comes a need to put at the disposal of those viewers more information and details about products and services featured in their TV shows or other media content they are exposed to.

Comments or discussions about specific products, services or simply ideas appropriate to visual elements available in media contents are normally exchanged through different channels including online using different chat rooms, blogs, social media websites (Facebook, Twitter, etc.) and many others. In general, those comments and discussions about those visual elements are placed in the same media space where those visual representations are published. For example, a web page, where a TV show can be streamed, lists underneath the playing video (TV show) comments and discussions about the TV show. The challenge is that web page may contain comments about different topics and the TV show viewer wants to only access the comments that he or she is interested and that are only linked to the targeted visual element or media content that they are exposed to at present, in where the need of linking comments about each topic to its relevant targeted visual representation.

This invention is a solution to address the above challenges but can be also extended to be applied in other fields. This invention enables media viewers to seamlessly access information, objects, details and comments of specific preferred visual representations at the same time of appearance of those visual elements.

### DRAWINGS

FIG. 1 is an illustration of a digital tablet device playing a movie and showing a person with sunglasses

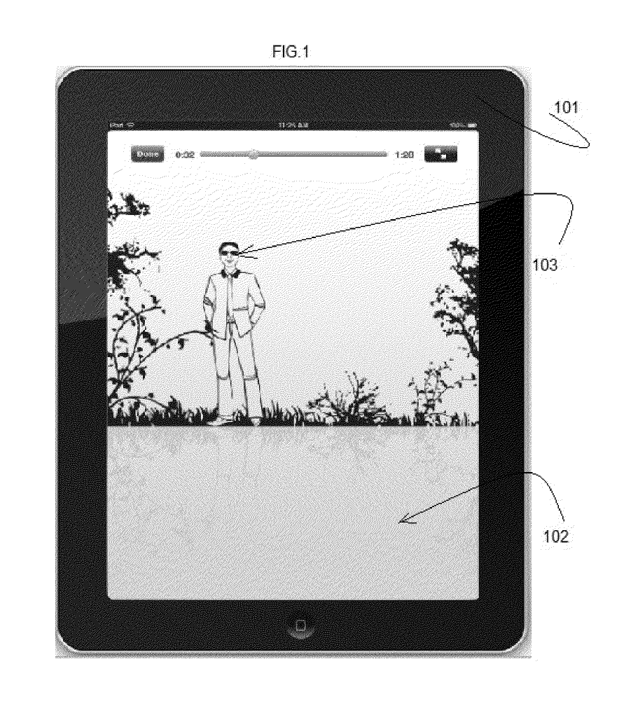

FIG. 2A contains the illustration of a digital tablet in addition to an illustration of the transparent layer that is on its way to be placed on the top of the movie media content

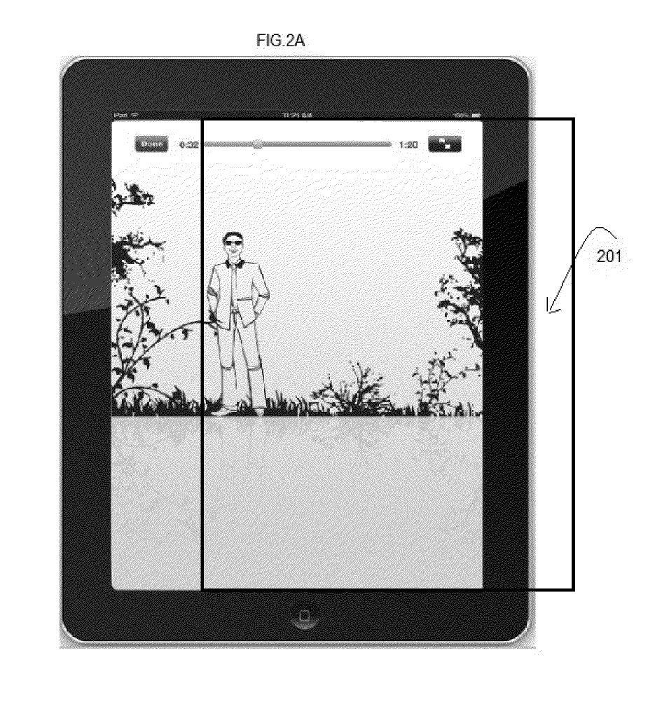

FIG. 2B is an illustration of the table with the transparent layer covering completely the video media content

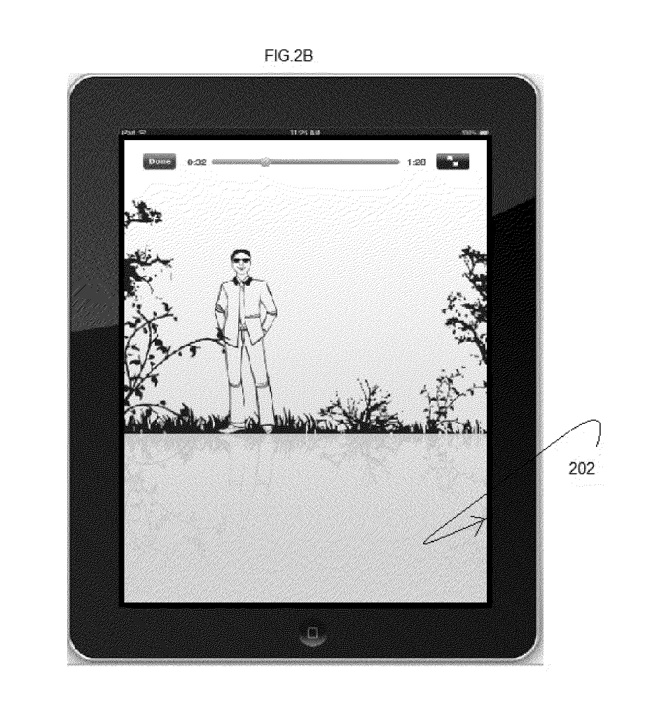

FIG. 3 is an illustration of the digital tablet and a movie in edit mode where appear the X and Y axis and the location of a tap event

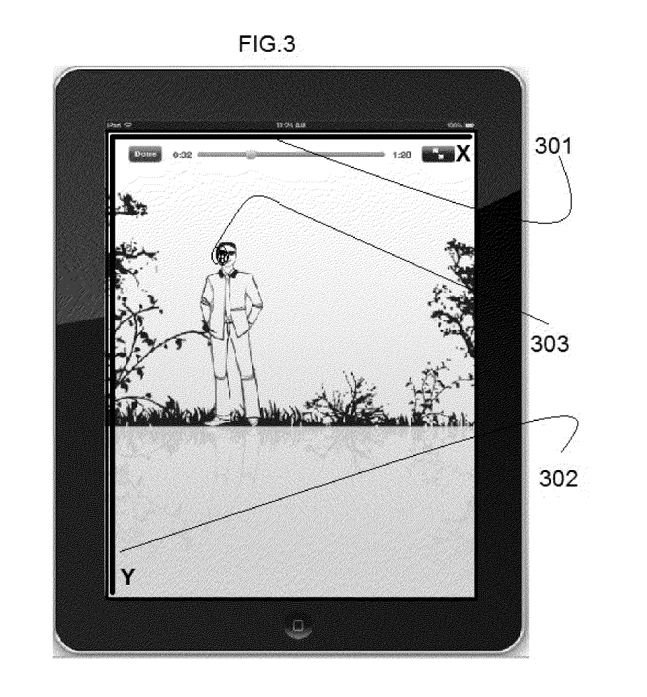

FIG. 4 is an illustration of the digital tablet with the movie in edit mode in addition to the projection of the location of the tapped visual element on X and Y axes

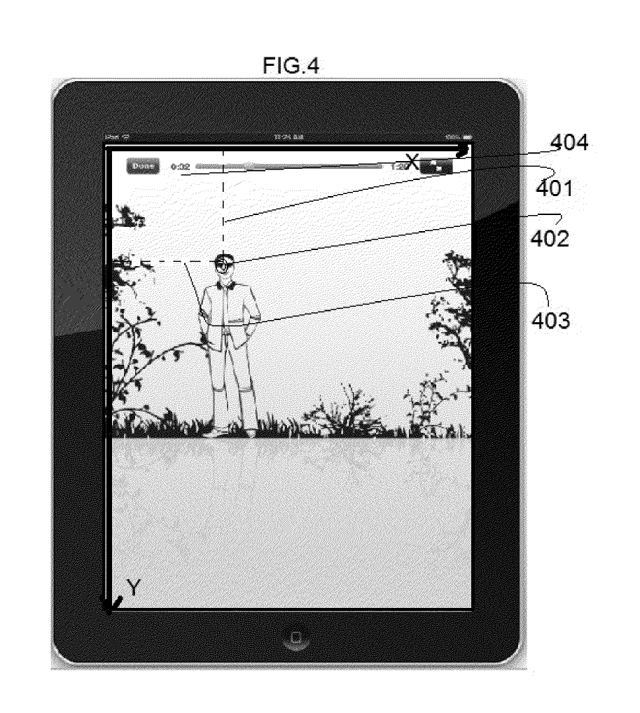

FIG. 5A is an illustration of the pop up list where the information and objects to be embedded can be entered then saved

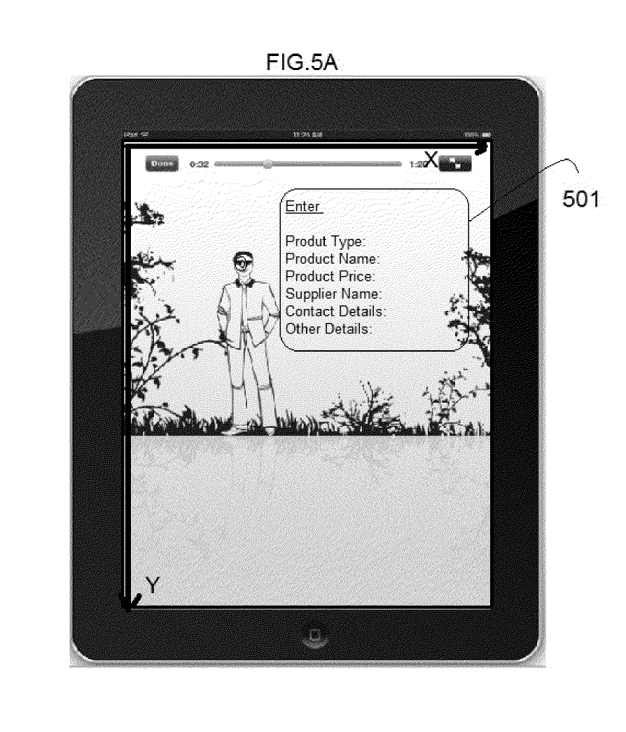

FIG. 5B is an illustration of the digital tablet with the entered information and objects to be embedded

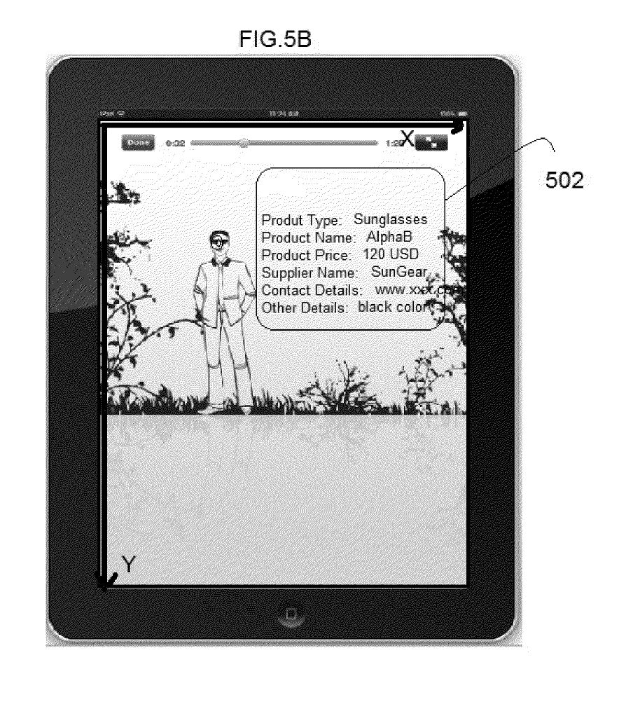

FIG. 6A contains the illustration of a movie media content with a tap event occurred an area surrounding the targeted visual element

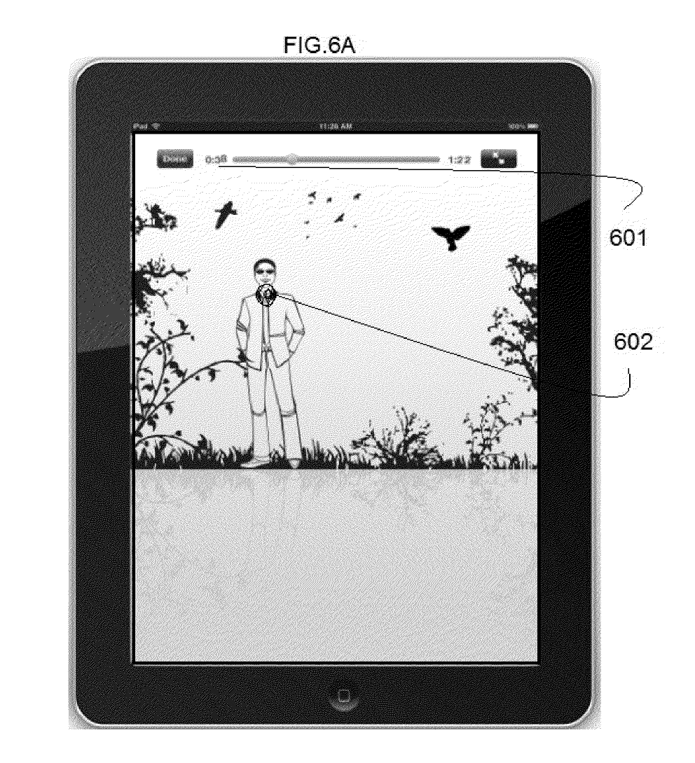

FIG. 6B is an illustration of the video media content with the unveiled embedded information and objects

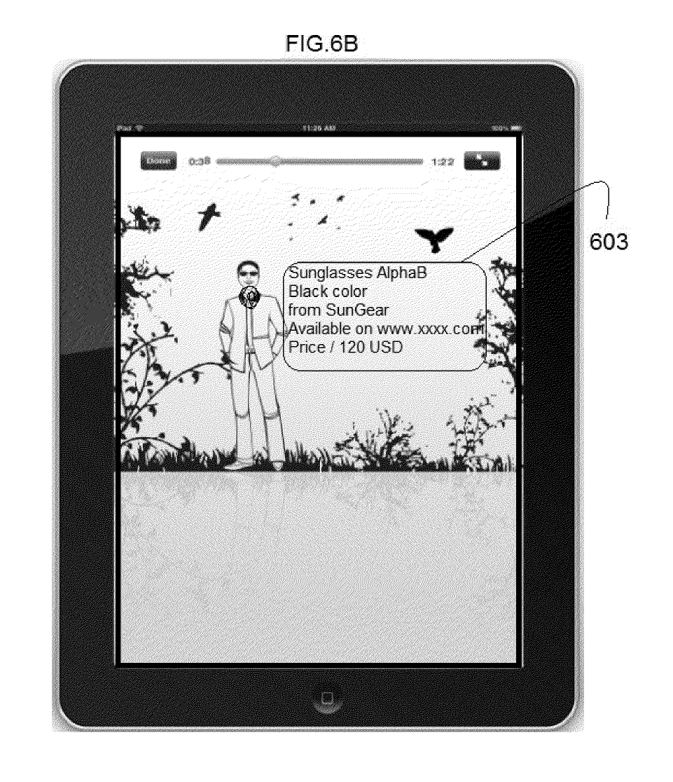

### DETAILED DESCRIPTION OF THE INVENTION

The present embodiments seek to provide a system and a method for embedding objects and information in a transparent layer placed on the top of a still image or a video media content.

Before explaining one of many embodiment of the invention in detail, it is to be understood that the invention is not limited in its application to the details of construction and the arrangement of the components set forth in the following description or illustrated in the drawings. The invention is capable of other embodiments or of being practiced or carried out in various ways. In addition, it is to be understood that the phraseology and terminology employed herein is for the purpose of description and should not be regarded as limiting.

Explaining the invention and its methods will be conducted through the example illustrated in the enclosed drawings in 5 major cycles: edit mode to embed information and objects 501, embedding then saving or storing information and objects 502, playing movie in view mode 601, a tap event 602 occurs to display the embedded data and information 603 proper to the targeted visual element 103.

In an illustrative embodiment, the invention may be practiced with different digital or electronic devices but for the purpose of this description, the digital tablet 101 is used and a specific scene 102 with a visual element 103 represented by sunglasses is targeted in this invention description.

The goal is to embed information and objects related to the targeted visual element 103 in the transparent layer 201 & 202 and not directly in the media content. To accomplish this mission, the user will place the transparent layer 201 which is computer software on the top of the video media content covering completely 202 the overall media player.

Embedding the objects and information is a task that has be conducted by user in edit mode. This embedding action requires first identifying the target visual element 103 by taping on the transparent layer 303 in an area overlapping with the visual element 103. Tap event occur at a specific elapsed time 404 represented by 0′28″ in this description. At the time of taping the transparent layer by the user, the Cartesian coordinates (X) 403 calculated because of X axis 301 & (Y) 401 calculated because of Y axis 302 of the location 402 where the tap event occurs will be captured and stored automatically by the transparent layer software.

The tap event in edit mode leads to a pop-up screen 501 where user can type then store the information and objects to be embedded 402. After saving the entered embedded information, the user get exposed to the same video media content in view mode can re-display any information or objects that are already embedded in the media player and that are related to proper visual element.

At the same elapsed time 404 or near this time 601, by tapping in the same location with Cartesian coordinates 401 & 403 or in a different near location 602 with Cartesian coordinates are near the values of 401 and 403, the user can display 603 the stored embedded information or objects of visual element 103.

Both the Cartesian coordinates or the location of visual element within the video media content in and the elapsed time of video media content are crucial to embed information and objects then redisplay them in a specific video media or still image contents.

### CONCLUSION

The core element of this invention is the transparent layer overlapping the video media, still image media or any other visual media contents. This transparent layer which is a computer code helps in embedding then recalling and displaying the embedded information and objects appropriate to any visual element. Other core element that is part of this invention is the usage of the Cartesian coordinates coupled with the elapsed time (in case of video playing) when embedding objects and information in visual media.

While various embodiments of the present invention breadth have been described above, it should be understood that they have been presented by way of example only, and not limitation. Accordingly, the scope of the present invention should not be limited by any of the above-described exemplary embodiments, but should be defined only in accordance with the provided claims and their equivalents.

What is claimed is:

1. A method comprising of embedding any objects and information in a transparent layer or medium placed on the top of any digital, broadcast or electronic media whatever the media content type such as still image or video;

2. The method of claim 1, wherein the transparent layer composed from software code and executable on one or more several digital and electronic devices but not limited to: mobile phones, TVs, PCs, computers, digital tablets and other devices;

3. The method of claim 1, wherein the transparent layer is placed on top of:
A video player where the video in a playing mode represents the video media content;
A still image that represents the image still media content
The goal is to associate selected visual elements contained in the video or still image media content with a set of embedded information and objects that could be redisplayed later on by users when they are exposed to the same visual element of the same video and still image media contents

4. The method of claim 1 comprises embedding objects and information in a transparent layer in specific selectable region defined by users. Each set of embedded objects and information are appropriate to specific visual element contained in video and still image media contents.

5. The method of claim 4, wherein the selectable region of embedded objects and information in the transparent layer are defined by users based on the location of visual element contained in the video media and still media contents. Those locations are normally overlapping or surrounding the targeted visual elements by users.

6. The method of claim 5, wherein the transparent layer is placed on the top of the video media content, the selection of location of each set of embedded objects and information in the transparent layer are defined by the location parameters such as the Cartesian coordinates X and Y of each visual element in the video media content. Each set of the embedded objects and information along with their proper Cartesian coordinates of each set of visual element and other video player parameters such as but not limited to the elapsed time captured at the time of appearance of each set of the visual representations when playing the video media content are all bundled and stored together on content servers, cloud database, devices memory and other storage media. The Cartesian coordinates and the elapsed time in addition to other captured and stored data (described in claim 8) will be accessible by users afterward as described in claims 11, 12, and 13.

7. The method of claim 5, wherein the transparent layer is placed on the top of the still image media content, the selection of location of each set of embedded objects and information in the transparent layer is defined by the location parameters such as the Cartesian coordinates X and Y of each visual element. Each set of the embedded objects and information along with their proper Cartesian coordinates of each set of visual element are all bundled and stored together on content servers, cloud database, devices memory and other storage media. The Cartesian coordinates in addition to other captured and stored data (described in claim 8) will be accessible by users afterward as described in claims 11,12 and 13.

8. Each set of stored data described in claim 6 and claim 7 can contain other additional values of attributes such as:
Name or Title of video and still image content media;
Other video player time parameters such as video duration, current time start time and end time;
Name of digital, electronic or broadcast media or parties that produce, display, publish or own the media video and image contents (where available);
Broadcast time of video or image media contents (where available);
And other elements that help in identifying the video or image media contents and the parties or broadcasting channels that communicate or share the contents to third parties (where available);
And others;

9. Embedding objects and information for selected visual element as described above requires special user access privilege; user in this case will be in edit mode. After finishing embedding the objects and information, the latters will either be saved automatically by the system or manually by the user.

10. Subsequently, users who will be exposed to the same visual element in view mode can access each set of embedded objects and information stored with their proper captured data detailed in claims 6, 7. The method of claim 9, wherein the user who gets exposed to the same visual element that have embedded information and objects, he/she can access the set of embedded information or objects and other related captured data upon conducting any of the following events: tap, mouse click, mouse over and other events conducted on the top of the transparent layer in a selected area that is overlapping or near the location of the visual element in their original video or still image media content. At the time of event occurrence, in addition to the values of attributes listed in claim 8, the system will capture and store automatically 3 major values such as: Cartesian coordinate X of the location where the event occurs on the transparent layer, Cartesian coordinate Y where the event occurs on the transparent layer and the current video elapsed time (in case of video media content) when the event occurs, in addition to other required information

11. The method of claim 10, wherein in view mode the values of the 3 major captured and stored values of parameters of a selected video media content will be matched with the values of the same parameters of the same video media content already stored in edit mode according to claims 6 and 8. If data matching exercise is successful or values of stored parameters are close matching to each other with a pre-defined differential margin then the user will have access to the set of objects and information already stored with such parameters values and that are already embedded in the transparent layer of the selected video media content. Otherwise, no objects & information will be accessible or displayed to the user.

12. The method of claim 11, wherein the values of the 2 major captured and stored parameters values—Cartesian X and Y coordinates—of a selected still image content media will be matched with the values of the same media content already stored according to claims 7 and 8. If data matching exercise is successful or parameters values are close matching to each other with a pre-defined differential margin then the user will have access to the set of objects and information already stored with such parameters values and that are already embedded in the transparent layer of the selected image still media content. Otherwise, no data will be accessible to the user.

13. The solution presents a platform that glues all the claims above and provides services to third party users. The transparent layer will be the medium used to present the embedded data and object on top of their relevant video and still image media contents wherever on which digital, broadcast or electronic media those media contents are displayed or published. An example of the advantage of using the transparent layer is that embedded data and information in there can be easily and seamlessly updated, replaced and reused at same time across many media displaying the same visual media contents. In addition the transparent layer can be exposed to third party to write into it or a centralized database can feed it.
